(19) United States
(12) Patent Application Publication
(10) Pub. No.: US 2012/0256986 A1
(43) Pub. Date: Oct. 11, 2012

(54) LIQUID EJECTING APPARATUS AND METHOD OF CONTROLLING LIQUID EJECTING APPARATUS

(75) Inventors: Masaru KOBASHI, Matsumoto (JP); Yoichi YAMADA, Shiojiri (JP); Toshiya OKADA, Chino (JP)

(73) Assignee: Seiko Epson Corporation, Tokyo (JP)

(21) Appl. No.: 13/438,387

(22) Filed: Apr. 3, 2012

(30) Foreign Application Priority Data
Apr. 5, 2011 (JP) 2011-083393

(51) Int. Cl. B41J 2/16

(52) U.S. Cl. 347/47

(57) ABSTRACT

A liquid ejecting apparatus includes a switch which performs switching between a platen applied voltage generation section side and the ground side with respect to a platen which supports a recording medium, wherein in a case where recording paper is present on the platen, the switch is switched to the ground side, so that the platen is set to have the same potential as that of a nozzle formation face, and on the other hand, in a case where the recording paper is not present on the platen, the switch is switched to the platen applied voltage generation section side, so that the platen is electrically charged to have negative polarity.

### BACKGROUND

1. Technical Field

The present invention relates to a liquid ejecting apparatus such as an ink jet type recording apparatus, and in particular, to a liquid ejecting apparatus which ejects liquid in a pressure chamber from a nozzle by driving a pressure generation section, and a method of controlling the liquid ejecting apparatus.

2. Related Art

A liquid ejecting apparatus is an apparatus which is provided with a liquid ejecting head and ejects various liquids from the liquid ejecting head. As the liquid ejecting apparatus, for example, there is an image recording apparatus such as an ink jet type printer or an ink jet type plotter. However, in recent years, the liquid ejecting apparatus has also been applied to various manufacturing apparatuses taking advantage of the feature of being capable of making a very small amount of liquid precisely land at a given position. It has been applied to, for example, a display manufacturing apparatus which manufactures a color filter of a liquid crystal display or the like, an electrode forming apparatus which forms an electrode of an organic EL (Electro Luminescence) display, an FED (a surface-emitting display), or the like, and a chip manufacturing apparatus which manufactures a biochip (a biochemical element). Then, in a recording head for the image recording apparatus, liquid ink is ejected, and in a color material ejecting head for the display manufacturing apparatus, a solution of each color material of R (red), G (green), and B (blue) is ejected. Further, in an electrode material ejecting head for the electrode forming apparatus, a liquid electrode material is ejected, and in a biological organic matter ejecting head for the chip manufacturing apparatus, a solution of biological organic matter is ejected.

In a recording head which is used in the printer or the like, in recent years, in order to meet the needs of improvement in image and the like, the amount of ink which is ejected from a nozzle tends to be reduced. In order to make such a very small amount of liquid droplet reliably land on a recording medium, the initial speed of the liquid droplet is set relatively high. In this way, the liquid droplet ejected from the nozzle is elongated during flight, thereby being divided into a leading main droplet (a main droplet) and a satellite droplet (a sub-droplet) after it. Some or all of the satellite droplets rapidly decrease in speed due to the viscous resistance of air, thereby being sometimes turned into mist without reaching the recording medium. Accordingly, there is a problem in that the satellite droplets (ink mist) turned into mist contaminate the inside of the apparatus, thereby causing malfunction by attachment to an easily charged member such as a recording head or an electric circuit.

In order to prevent such a defect, an attempt has been made to actively attract a liquid droplet which is ejected from the nozzle, to a support member (or a platen or a base material) which supports a recording medium at the time of recording, thereby making the liquid droplet land on the recording medium, by electrically charging the liquid droplet and also forming an electric field between a nozzle formation face of the recording head and the support member (or the platen or the base material) (refer to JP-A-10-278252 or JP-A-2004-202867, for example).

However, as shown in a schematic diagram of FIG. 9A, in a process in which ink ejected from a nozzle 64 of a recording head stretches toward a recording medium P and a support member 65, negative charges are induced in a leading portion (a portion which becomes a main droplet Md) on the side close to the support member 65 due to electrostatic induction from the positively charged support member 65 and on the other hand, in a rear end portion on the side close to the nozzle 64 which is opposite to the support member 65, positive charges are induced. Then, as shown in FIG. 9B, in a case where ink ejected from the nozzle has been divided into, for example, a main droplet Md, a first satellite droplet Sd1, and second satellite droplets (mist) Sd2, the main droplet Md is negatively charged, the second satellite droplets Sd2 are positively charged, and the first satellite droplet Sd1 is not electrically charged. In this case, even if the main droplet Md and the first satellite droplet Sd1 land on the recording medium P, the second satellite droplets Sd2 repel against the positively charged support member 65, thereby being turned into mist and suspended in vicinity of a nozzle formation face of the recording head. Some of the mist attach to the nozzle formation face. In a case where mist is attached to the nozzle formation face, there is a need to regularly sweep the nozzle formation face by a wiping member. Further, there is concern that mist which has not been attached to the nozzle formation face may attach to and contaminate a printer component which has polarity different from that of the mist.

In terms of those as described above, a configuration has also been proposed in which an electrode is provided in the vicinity of a nozzle, and if ejection of ink from the nozzle is started, the polarity of the electrode is switched, for example, from positive to negative, and at timing when ink ejected from the nozzle has been divided into a main droplet and a satellite droplet, control to switch the polarity of the electrode again to the positive is performed, so that the positively charged satellite droplet is distanced from a nozzle formation face (directed to a recording medium) (refer to JP-A-2010-214652, for example). Further, a configuration has also been proposed in which ink is ejected from a nozzle in a state where a support member (a base material) has been charged negatively, for example, and at timing when an ink droplet has been divided into a main droplet and a satellite droplet, the polarity of the support member is switched to positive, so that the main droplet lands on a recording medium due to an inertial force and on the other hand, the satellite droplet or mist is attracted to the support member electrically charged to have the opposite polarity to that of the satellite droplet or the mist, thereby landing in the recording medium (refer to JP-A-2010-214880, for example).

However, in recent years, in this type of printer, the drive frequency for ejecting ink tends to become higher, whereby a case occurs where before the satellite droplet lands on the recording medium, the next ink is ejected from the nozzle. For this reason, in the configuration in which the polarity of the electrode is switched at the ink ejection timing or the timing when ink is divided, as described above, in addition to making it difficult for the satellite droplet to reliably land on the recording medium, the influence on flight of the main droplet occurs, so that there is a possibility that landing may become unstable.

Further, the configuration of making an electric field not be formed between the nozzle formation face and the support member in order to prevent electrical charging of ink is also conceivable. However, even in the case of ejecting ink from the nozzle in the configuration, it can be found that the ejected ink is electrically charged. That is, for example, as in a schematic diagram shown in FIG. 10, in a configuration in which a fluctuation in pressure is caused in ink in a pressure chamber 70 by applying driving voltage to a driving electrode 69 of a piezoelectric vibrator 68 of a recording head and ink is ejected from a nozzle 71 to a recording medium P with use of the fluctuation in pressure, when positive voltage has been input to the driving electrode 69 of the piezoelectric vibrator 68, since the piezoelectric vibrator 68 and the pressure chamber 70 are insulated from each other, negative charges are induced in ink in the vicinity of the piezoelectric vibrator 68 in the pressure chamber 70 due to electrostatic induction. Further, in ink in the vicinity of the nozzle 71 which becomes the opposite side to the piezoelectric vibrator 68, positive charges are induced. In a general recording head, a nozzle formation face 72 is earthed (grounded), so that the positive charges of ink move to the nozzle formation face 72 side. However, as described above, in a configuration in which ink is ejected with higher drive frequency, ink is ejected from the nozzle 71 in a state where positive charges slightly remain. As a result, ink ejected from the nozzle 71 is positively charged.

Further, in ink ejected from the nozzle 71, while it flies toward the recording medium P, positive charging tends to increase due to the Lenard effect (in a case where ink is ejected in a negatively charged state, negative tends to decrease). That is, in a case where ink is electrically charged, positive charges are collected at the central portion of a liquid droplet, while negative charges are collected at the surface layer portion of the liquid droplet. Then, the liquid droplet is gradually biased to positive by evaporation or disintegration of the surface layer portion during flight.

In this manner, even in the configuration of making an electric field not be formed between the nozzle formation face and the support member, since ink ejected from the nozzle is electrically charged, a defect in that mist attaches to the nozzle formation face or a component of a printer occurs.

A phenomenon as described above similarly occurs not only in a piezoelectric vibrator, but also in another pressure generation section which is operated by application of driving voltage, such as a heat generation element.

### SUMMARY

An advantage of some aspects of the invention is that it provides a liquid ejecting apparatus in which it is possible to more reliably collect mist, thereby preventing contamination of the inside of the apparatus, and a method of controlling the liquid ejecting apparatus.

According to an aspect of the invention, there is provided a liquid ejecting apparatus including: a liquid ejecting head which includes a nozzle formation face in which nozzles that eject liquid are formed and a pressure generation section which is driven by application of a driving signal, thereby causing a fluctuation in pressure in the liquid in a pressure chamber which communicates with each nozzle, and ejects the liquid from the nozzle toward a landing target by driving of the pressure generation section; a driving signal generation section which generates the driving signal that drives the pressure generation section; a support section which is disposed spaced apart from the nozzle formation face of the liquid ejecting head when performing an ejection operation and supports the landing target; a support section potential setting section which sets the potential of the support section to be the same potential as that of the nozzle formation face; and a voltage application section which applies voltage having negative polarity to the support section, wherein in a case where the landing target is present on the support section, the support section is set to have the same potential as that of the nozzle formation face by the support section potential setting section, and on the other hand, in a case where the landing target is not present on the support section, the support section is electrically charged to have negative polarity by the voltage application section.

According to the above aspect of the invention, in a case where the landing target is present on the support section, the support section is set to have the same potential as that of the nozzle formation face, and on the other hand, in a case where the landing target is not present on the support section, the support section is electrically charged to have negative polarity by the voltage application section. In this way, it becomes possible to collect mist positively charged without landing in the landing target, to the support section electrically charged to have negative polarity, by an electrostatic force. As a result, attachment of mist to a component (for example, a driving motor, a driving belt, a linear scale, or the like) in the apparatus is reduced. As a result, a breakdown due to attachment of mist is prevented, so that durability and reliability of the liquid ejecting apparatus are improved.

In the above configuration, the voltage application section may apply voltage to the support section at the point of time when the liquid ejecting head has moved to a position where the nozzle formation face and the support section do not face each other.

Further, according to another aspect of the invention, there is provided a liquid ejecting apparatus including: a liquid ejecting head which includes a nozzle formation face in which nozzles that eject liquid are formed and a pressure generation section which is driven by application of a driving signal, thereby causing a fluctuation in pressure in the liquid in a pressure chamber which communicates with each nozzle, and ejects the liquid from the nozzle toward a landing target by driving of the pressure generation section; a driving signal generation section which generates the driving signal that drives the pressure generation section; a support section which is disposed spaced apart from the nozzle formation face of the liquid ejecting head when performing an ejection operation and supports the landing target; a landing target potential setting section which sets the potential of the landing target that is transported to the support section to be the same potential as that of the nozzle formation face; and a voltage application section which applies voltage having negative polarity to the support section.

According to the configuration of the above aspect, in a state where the landing target is transported onto the support section and a liquid ejecting process is then carried out on the landing target, the nozzle formation face and the landing target have the same potential, so that an electric field is not formed between the two. Further, if a state is created where the landing target is not present on the support section, since the support section is electrically charged to have negative polarity, it becomes possible to collect mist positively charged without landing in the landing target, to the support section by electrostatic force. As a result, attachment of mist to a component (for example, a driving motor, a driving belt, a linear scale, or the like) in the apparatus is reduced. As a result, a breakdown due to attachment of mist is prevented, so that durability and reliability of the liquid ejecting apparatus are improved.

Further, in each configuration described above, the support section may include an absorber capable of absorbing a liquid droplet and having conductivity and the voltage application section may apply voltage having negative polarity to the absorber.

According to the above configuration, attachment of mist to a main body of the support section is suppressed. In this way, attachment of ink to the landing target is reduced.

Further, according to still another aspect of the invention, there is provided a method of controlling a liquid ejecting apparatus which includes a liquid ejecting head which includes a nozzle formation face in which nozzles that eject liquid are formed and a pressure generation section which is driven by application of a driving signal, thereby causing a fluctuation in pressure in the liquid in a pressure chamber which communicates with each nozzle, and ejects the liquid from the nozzle toward a landing target by driving of the pressure generation section; a driving signal generation section which generates the driving signal that drives the pressure generation section; a support section which is disposed spaced apart from the nozzle formation face of the liquid ejecting head when performing an ejection operation and supports the landing target; a support section potential setting section which sets the potential of the support section to be the same potential as that of the nozzle formation face; and a voltage application section which applies voltage having negative polarity to the support section, the method including: setting the support section to have the same potential as that of the nozzle formation face by the support section potential setting section in a case where the landing target is present on the support section; and on the other hand, electrically charging the support section to have negative polarity by the voltage application section in a case where the landing target is not present on the support section.

### BRIEF DESCRIPTION OF THE DRAWINGS

The invention will be described with reference to the accompanying drawings, wherein like numbers reference like elements.

FIG. 1 is a perspective view describing the configuration of a printer.

FIGS. 2A and 2B are diagrams describing the configuration of a platen.

FIG. 3 is a cross-sectional view of a main section of a recording head.

FIG. 4 is a cross-sectional view describing the configuration of a piezoelectric vibrator.

FIG. 5 is a block diagram describing the electrical configuration of the printer.

FIG. 6 is a waveform diagram describing the configuration of an ejection driving pulse of a driving signal.

FIGS. 7A and 7B are schematic diagrams describing collection of mist.

FIGS. 8A and 8B are schematic diagrams describing a configuration related to a second embodiment.

FIGS. 9A and 9B are schematic diagrams describing a state where ink ejected from a nozzle is electrically charged in a configuration in which an electric field has been formed between the nozzle and a support member.

FIG. 10 is a schematic diagram describing a state where ink ejected from a nozzle is electrically charged in a configuration in which an electric field is not formed between the nozzle and the support member.

### DESCRIPTION OF EXEMPLARY EMBODIMENTS

Hereinafter, a mode for carrying out the invention will be described with reference to the accompanying drawings. In addition, although in embodiments which are described below, various limitations are given as preferred specific examples of the invention, the scope of the invention is not limited to these aspects unless the description of intent to limit the invention is particularly provided in the following description. Also, in the following description, an ink jet type recording apparatus (hereinafter, referred to as a printer) is taken and described as an example of a liquid ejecting apparatus according to the invention.

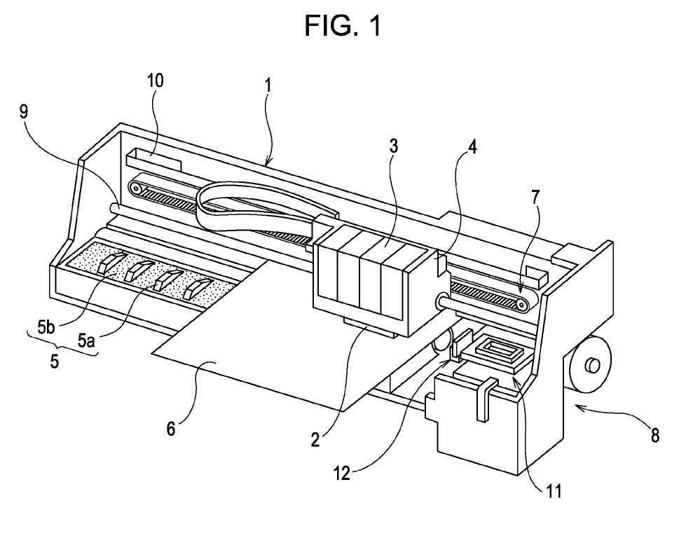

FIG. 1 is a perspective view showing the configuration of a printer 1. The printer 1 includes a carriage 4, on which a recording head 2 that is one type of a liquid ejecting head is mounted and also an ink cartridge 3 that is one type of a liquid supply source is detachably mounted, a platen 5 disposed below the recording head 2 at the time of a recording operation, a carriage movement mechanism 7 which reciprocates the carriage 4 in the paper width direction of recording paper 6 (one type of each of a recording medium and a landing target), that is, a main scanning direction, and a transport mechanism 8 which transports the recording paper 6 in a sub-scanning direction perpendicular to the main scanning direction.

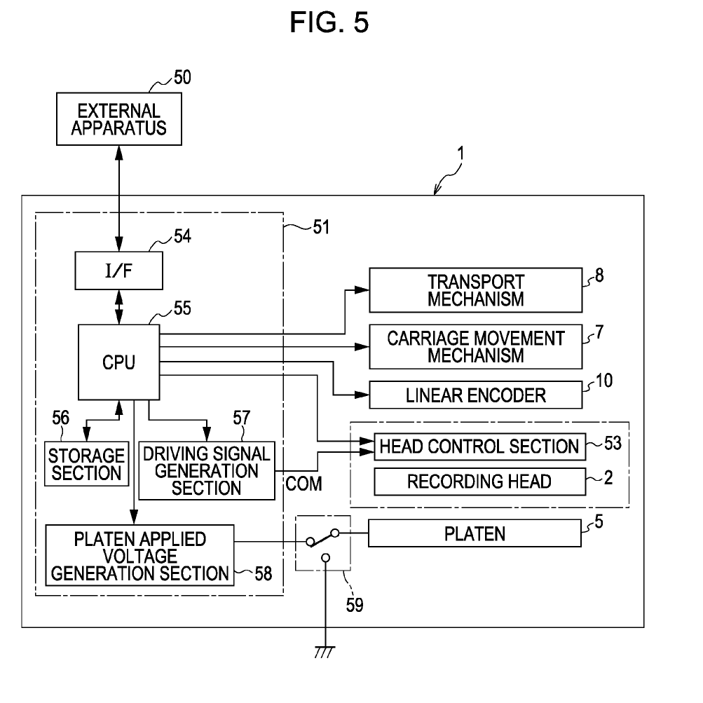

The carriage 4 is mounted in a state where it is pivotally supported on a guide rod 9 provided to extend in the main scanning direction, and is configured so as to move in the main scanning direction along the guide rod 9 by an operation of the carriage movement mechanism 7. A position in the main scanning direction of the carriage 4 is detected by a linear encoder 10 and the detection signal, that is, an encoder pulse (one type of position information) is transmitted to a printer controller 51 (refer to FIG. 5). The linear encoder 10 is one type of a position information output section and outputs an encoder pulse according to a scanning position of the recording head 2, as position information in the main scanning direction.

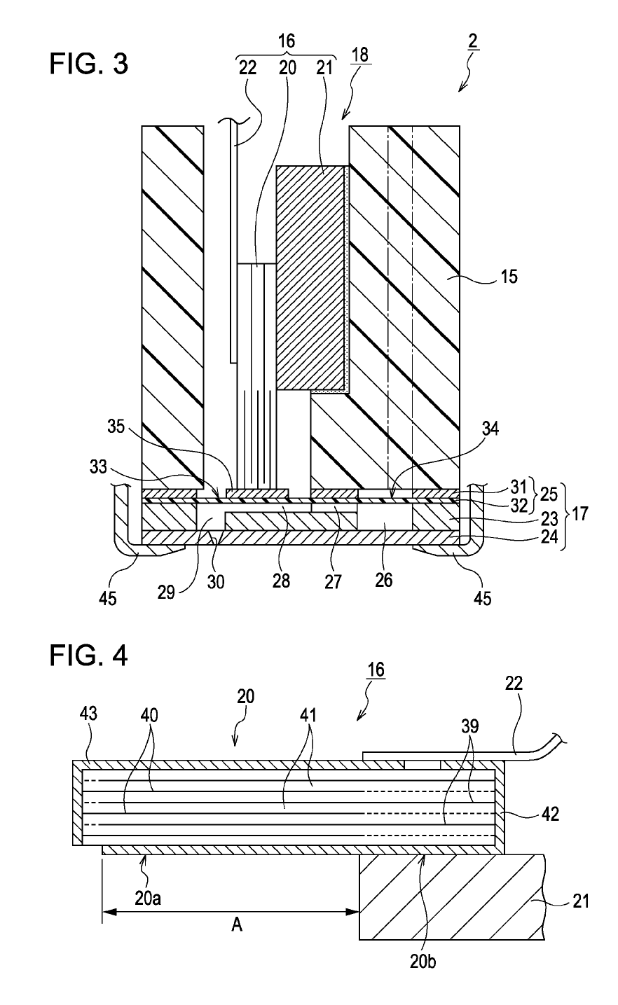

At an end portion area further outside than a recording area within a movement range of the carriage 4, a home position that becomes a base point of scanning of the carriage is set. At the home position in this embodiment, a capping member 11 which seals a nozzle formation face (a nozzle plate 24; refer to FIG. 3) of the recording head 2 and a wiper member 12 for sweeping the nozzle formation face are disposed. Then, the printer 1 is configured such that so-called bi-directional recording is possible which records a character, an image, or the like on the recording paper 6 in both directions at the time of forward movement in which the carriage 4 moves from the home position toward an end portion on the opposite side and the time of return movement in which the carriage 4 returns from the end portion on the opposite side to the home position side.

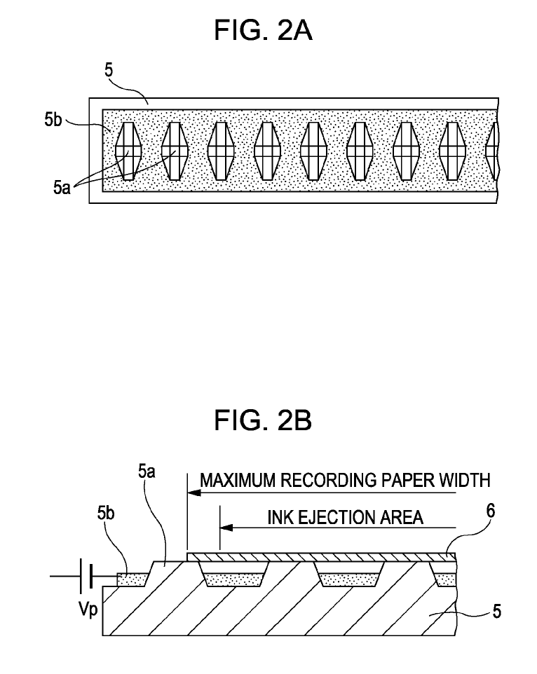

FIGS. 2A and 2B are diagrams describing the configuration of the platen 5, wherein FIG. 2A is a fragmentary plan view and FIG. 2B is a fragmentary cross-sectional view in a longitudinal direction. The platen 5 in this embodiment is a plate-like member which is long in the main scanning direction, and on the surface thereof, a plurality of support projections 5a is provided in a protruding state at given intervals along the longitudinal direction. Each support projection 5a protrudes further to the upper side (the recording head 2 side at the time of the recording operation) than the surface of the platen. The upper surface of each support projection 5a serves as a contact surface which supports the rear surface (the surface on the opposite side to a recording surface on which ink lands) of the recording paper 6. Further, at a portion deviated from each support projection 5a in the surface of the platen 5, an ink absorber 5b (one type of an absorber in the invention) is disposed. The ink absorber 5b is formed of a porous member made of, for example, felt, sponge, or the like and having liquid absorptivity. At least a portion of the platen 5 in this embodiment is formed of a material having conductivity. For example, by including an electrically-conductive material such as carbon in a material of a main body of the platen 5, conductivity is given to the platen 5. Otherwise, it is also acceptable to make the ink absorber 5b have conductivity by including an electrically-conductive material in a material of the ink absorber 5b. In this embodiment, while the main body of the platen 5 has insulating properties, the ink absorber 5a has conductivity. Then, a configuration is made such that voltage from a platen applied voltage generation section 58, which will be described later, is applied to the ink absorber 5b. The details in this respect will be described later.

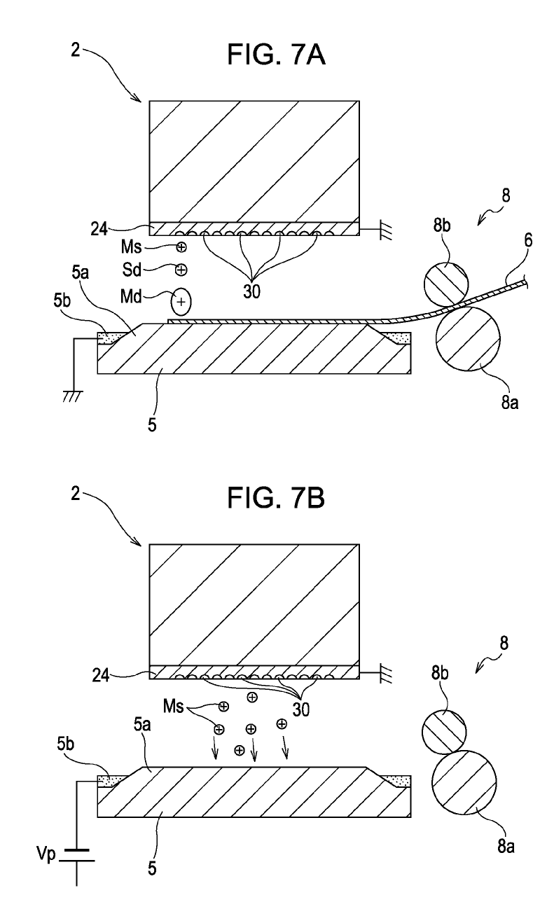

The transport mechanism 8 includes a feed driving roller 8a which is rotationally driven by a motor, and a feed driven roller 8b which is driven and rotated in pressure contact with the feed driving roller 8a (refer to FIGS. 7A and 7B). The recording paper 6 which has reached the transport mechanism 8 from a paper feed tray (not shown) is transported to the platen 5 side by rotation of the feed driving roller 8a in a state where the recording paper 6 is pinched (nipped) by the feed driving roller 8a and the feed driven roller 8b. The recording sheet 6 with an image or the like recorded on the recording surface is discharged to a paper discharge tray (not shown) side.

FIG. 3 is a cross-sectional view of a main section describing the configuration of the recording head 2. The recording head 2 includes a case 15, a vibrator unit 16 which is accommodated in the case 15, a flow path unit 17 which is joined to the bottom face (the leading end face) of the case 15, a cover member 45, and the like. The case 15 is made of, for example, epoxy-based resin, and in the inside thereof, an accommodating cavity portion 18 for accommodating the vibrator unit 16 is formed. The vibrator unit 16 includes a piezoelectric vibrator 20 which functions as one type of a pressure generation section, a fixed plate 21 to which the piezoelectric vibrator 20 is joined, and a flexible cable 22 which supplies a driving signal to the piezoelectric vibrator 20.

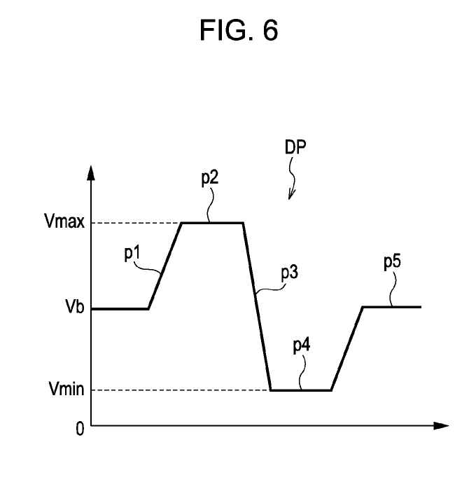

FIG. 4 is a cross-sectional view in a longitudinal direction of an element, which describes the configuration of the vibrator unit 16. As shown in the drawing, the piezoelectric vibrator 20 is a lamination type piezoelectric vibrator formed by alternately laminating a common internal electrode 39 and an individual internal electrode 40 with a piezoelectric body 41 interposed therebetween. Here, the common internal electrode 39 is an electrode common to all the piezoelectric vibrators 20 and is set to have a ground potential. Further, the individual internal electrode 40 is an electrode in which a potential varies according to an ejection driving pulse DP (refer to FIG. 6) of a driving signal which is applied thereto. Then, in this embodiment, a portion from a leading end of the vibrator to about half or about two-thirds in a longitudinal direction (a direction perpendicular to a lamination direction) of the vibrator in the piezoelectric vibrator 20 becomes a free end portion 20a. Further, the remaining portion in the piezoelectric vibrator 20, that is, a portion from a base end of the free end portion 20a to a base end of the vibrator becomes a base end portion 20b.

At the free end portion 20a, an active region (an overlap portion) A in which the common internal electrode 39 and the individual internal electrode 40 overlap each other is formed. If a difference in potential is imposed to these internal electrodes 39 and 40, the piezoelectric body 41 in the active region A operates to be deformed, so that the free end portion 20a is displaced in the longitudinal direction of the vibrator to expand or contract. Then, a base end of the common internal electrode 39 is electrically connected to a common external electrode 42 at a base end face portion of the piezoelectric vibrator 20. On the other hand, a leading end of the individual internal electrode 40 is electrically connected to an individual external electrode 43 at a leading end face portion of the piezoelectric vibrator 20. In addition, a leading end of the common internal electrode 39 is located slightly ahead of (further on the base end face side than) the leading end face portion of the piezoelectric vibrator 20 and a base end of the individual internal electrode 40 is located at the boundary between the free end portion 20a and the base end portion 20b.

The individual external electrode 43 (equivalent to a driving electrode in the invention) is an electrode formed to be successive in the leading end face portion of the piezoelectric vibrator 20 and a wiring connection face (a face on the upper side in FIG. 4) that is one side face in the lamination direction of the piezoelectric vibrator 20 and electrically connects a wiring pattern of the flexible cable 22 as a wiring member and each individual internal electrode 40 to each other. Then, the portion on the wiring connection face side of the individual external electrode 43 is continuously formed from above the base end portion 20b toward the leading end side. The common external electrode 42 is an electrode formed to be successive in the base end face portion of the piezoelectric vibrator 20, the wiring connection face, and a fixed plate mounting face (a face on the lower side in FIG. 4) that is the other side face in the lamination direction of the piezoelectric vibrator 20 and electrically connects the wiring pattern of the flexible cable 22 and each common internal electrode 39 to each other. Then, the portion on the wiring connection face side of the common external electrode 42 is continuously formed from just before an end portion of the individual external electrode 43 toward the base end face side, and the portion on the fixed plate mounting face side is continuously formed from a position just before the leading end face portion of the vibrator toward the base end side.

The base end portion 20b is a non-operation portion which does not expand and contract even at the time of an operation of the piezoelectric body 41 in the active region A. On the wiring connection face side of the base end portion 20b, the flexible cable 22 is disposed, and the individual external electrode 43 and the common external electrode 42 are electrically connected to the flexible cable 22 above the base end portion 20b. Then, a driving signal is applied to each individual external electrode 43 through the flexible cable 22.

The flow path unit 17 is configured by joining the nozzle plate 24 to the face on one side of a flow path formation substrate 23 and joining a vibration plate 25 to the face on the other side of the flow path formation substrate 23. In the flow path unit 17, a reservoir 26 (a common liquid chamber), an ink supply port 27, a pressure chamber 28, a nozzle communication port 29, and a nozzle 30 are provided. Then, a successive ink flow path from the ink supply port 27 through the pressure chamber 28 and the nozzle communication port 29 to the nozzle 30 is formed corresponding to each nozzle 30.

The nozzle plate 24 is a thin plate made of metal such as stainless steel, in which a plurality of nozzles 30 is perforated in a row at a pitch (for example, 180 dpi) corresponding to dot formation density. In the nozzle plate 24, the nozzles 30 are arranged in a row, so that a nozzle row (a nozzle group) is provided in a plurality, and one nozzle row is composed of 180 nozzles 30, for example. The face on the side where ink is ejected from the nozzles 30 of the nozzle plate 24 is equivalent to the nozzle formation face in the invention.

The vibration plate 25 has a double structure in which an elastic body film 32 is laminated on the surface of a support plate 31. In this embodiment, the vibration plate 25 is made by using a composite plate material in which a stainless steel plate that is one type of a metal plate is used as the support plate 31 and a resin film as the elastic body film 32 is laminated on the surface of the support plate 31. In the vibration plate 25, a diaphragm portion 33 which changes the volume of the pressure chamber 28 is provided. Further, in the vibration plate 25, a compliance portion 34 which seals a portion of the reservoir 26 is provided.

The diaphragm portion 33 is made by partially removing the support plate 31 by etching or the like. That is, the diaphragm portion 33 is composed of an island portion 35 to which the leaning end face of the free end portion 20a of the piezoelectric vibrator 20 is joined and a thin-walled elastic portion 36 which surrounds the island portion 35. The compliance portion 34 is made by removing the support plate 31 in an area facing an opening face of the reservoir 26 by etching or the like, similarly to the diaphragm portion 33, and functions as a damper which absorbs a fluctuation in pressure of liquid retained in the reservoir 26.

Then, since the leading end face of the piezoelectric vibrator 20 is joined to the island portion 35, the volume of the pressure chamber 28 can be fluctuated by expansion and contraction of the free end portion 20a of the piezoelectric vibrator 20. A fluctuation in pressure occurs in ink in the pressure chamber 28 in accordance with the fluctuation in volume. Then, the recording head 2 ejects ink from the nozzle 30 with use of the fluctuation in pressure.

The cover member 45 is a member which protects the side face of the flow path unit 17 or the side face of the case 15, and is made by a plate material having conductivity, such as stainless steel. A portion of the cover member 45 in this embodiment comes into contact with a peripheral portion of the nozzle formation face in a state where the nozzles 30 of the nozzle plate 24 are exposed, and is electrically connected to the nozzle plate 24. The cover member 45 is grounded and comes into contact with the nozzle plate 24 in an electrical conduction state, whereby damage to a driving IC or the like or electrical charging of the nozzle plate 24 due to static electricity which is generated from, for example, the recording paper 6 or the like and then transmitted thereto through the nozzle plate 24 is prevented.

Next, the electrical configuration of the printer 1 will be described.

FIG. 5 is a block diagram describing the electrical configuration of the printer 1. An external apparatus 50 is an electronic apparatus which deals with an image of a computer or a digital camera, or the like, for example. The external apparatus 50 is connected to the printer 1 so as to be able to communicate therewith and transmits printing data corresponding to an image or the like to the printer 1 in order to print the image or a text on a recording medium such as recording paper in the printer 1.

The printer 1 in this embodiment includes the transport mechanism 8, the carriage movement mechanism 7, the linear encoder 10, the recording head 2, and the printer controller 51.

The printer controller 51 is a control unit for performing control of each section of the printer. The printer controller 51 includes an interface (L/F) section 54, a CPU 55, a storage section 56, a driving signal generation section 57, and the platen applied voltage generation section 58. The interface section 54 performs transmission and receipt of printer state data, such as sending printing data or printing instructions from the external apparatus 50 to the printer 1 or sending the state information of the printer 1 to the external apparatus 50. The CPU 55 is an arithmetic processing device for performing control of the whole of the printer. The storage section 56 is an element which stores a program of the CPU 55 or data which is used in a variety of control, and includes a ROM, a RAM, and an NVRAM (a non-volatile memory element). The CPU 55 controls each unit in accordance with a program which is stored in the storage section 56.

The CPU 55 functions as a timing pulse generation section which generates a timing pulse PTS from an encoder pulse EP which is output from the linear encoder 10. Then, the CPU 55 controls transmission of the printing data, generation of a driving signal COM by the driving signal generation section 57, or the like in synchronization with the timing pulse PTS. Further, the CPU 55 generates a timing signal such as a latch signal LAT on the basis of the timing pulse PTS and outputs it to a head control section 53 of the recording head 2. The head control section 53 performs control or the like of application of the ejection driving pulse DP (refer to FIG. 6) of the driving signal COM to the piezoelectric vibrator 20 of the recording head 2 on the basis of a head control signal (the printing data and the timing signal) from the printer controller 51.

The platen applied voltage generation section 58 (equivalent to a voltage application section in this invention) functions as an electric power supply which generates voltage that is applied to the platen 5, and is electrically connected to the platen 5 through a switch 59. In this embodiment, a configuration is made such that the ink absorber 5b is negatively charged by applying negative voltage to the ink absorber 5b of the platen 5. The switch 59 is configured so as to switch a pathway to the platen 5 between the platen applied voltage generation section 58 side and the ground side by control of the CPU 55. The CPU 55 determines whether or not the recording paper 6 is present on the platen 5, on the basis of the transport amount of the recording paper 6 by the transport mechanism 8, and performs switching of the switch 59 on the basis of the determination. Specifically, in a state where the recording paper 6 has been transported onto the platen 5 (a state where the recording paper 6 is present on the platen 5), the switch 59 is switched to the ground side. In this way, a state is created where the ink absorber 5b is grounded without application of voltage thereto, so that the ink absorber 5b has the same potential as that of the nozzle plate 24 grounded through the cover member 45, as described above. For this reason, an electric field is not formed between the nozzle plate 24 and the platen 5 (the ink absorber 5b). That is, the switch 59 also functions as a support section potential setting section in the invention. On the other hand, in a state where the recording paper 6 is not present on the platen 5, the switch 59 is switched to the platen applied voltage generation section 58 side. In this way, a state is created where voltage is applied to the ink absorber 5b, so that an electric field is formed between the nozzle plate 24 and the platen 5. The details in this respect will be described later.

The driving signal generation section 57 generates an analog voltage signal on the basis of wavelength data related to the waveform of the driving signal. Further, the driving signal generation section 57 amplifies the voltage signal, thereby generating the driving signal COM. The driving signal COM is a signal which is applied to the piezoelectric vibrator 20 that is a pressure generation section of the recording head 2 at the time of a printing process (a recording process or an ejection process) on the recording medium, and is a successive signal which includes at least one or more ejection driving pulses DP shown in FIG. 6, for example, within a unit period that is a repetition period. Here, the ejection driving pulse DP is for making the piezoelectric vibrator 20 carry out a given operation in order to eject droplet-shaped ink from the nozzle 30 of the recording head 2.

FIG. 6 is a waveform diagram showing one example of the configuration of the ejection driving pulse DP which is included in the driving signal COM. In addition, in FIG. 6, the vertical axis denotes a potential and the horizontal axis denotes a time. Further, the ejection driving pulse DP includes an expansion element p1 in which a potential changes to the positive side from a reference potential (an intermediate potential) Vb to a maximum potential (a maximum voltage) Vmax, thereby expanding the pressure chamber 28, an expansion maintaining element p2 which maintains the maximum potential Vmax for a given length of time, a contraction element p3 in which a potential changes to the negative side from the maximum potential Vmax to a minimum potential (a minimum voltage) Vmin, thereby rapidly contracting the pressure chamber 28, a contraction maintaining (vibration suppression holding) element p4 which maintains the minimum potential Vmin for a given length of time, and a return element p5 in which a potential returns from the minimum potential Vmin to the reference potential Vb.

If the ejection driving pulse DP is applied to the piezoelectric vibrator 20, an operation is performed as follows. First, the piezoelectric vibrator 20 contracts due to the expansion element p1, whereby the pressure chamber 28 expands from the reference volume corresponding to the reference potential Vb to the maximum volume corresponding to the maximum potential Vmax. In this way, a meniscus which is exposed in the nozzle 30 is drawn to the pressure chamber side. An expansion state of the pressure chamber 28 is constantly maintained during an application period of the expansion maintaining element p2. If the contraction element p3 is applied to the piezoelectric vibrator 20 subsequently to the expansion maintaining element p2, the piezoelectric vibrator 20 expands, whereby the pressure chamber 28 rapidly contracts from the maximum volume to the minimum volume corresponding to the minimum potential Vmin. Ink in the pressure chamber 28 is pressurized due to rapid contraction of the pressure chamber 28, and in this way, ink of several p1 to several tens of p1 is ejected from the nozzle 30. An contraction state of the pressure chamber 28 is maintained for a short time over an application period of the contraction maintaining element p4, and thereafter, the return element p5 is applied to the piezoelectric vibrator 20, so that the pressure chamber 28 returns from a volume corresponding to the minimum potential Vmin to the reference volume corresponding to the reference potential Vb.

In the printer 1 according to the embodiment of the invention, a feature is that mist occurring with ejection of an ink droplet is collected with use of the fact that an ink droplet which is ejected from the nozzle 30 of the recording head 2 is positively charged by driving the piezoelectric vibrator 20 by application of the driving signal COM (the ejection driving pulse DP) described above, that is, application of voltage having positive polarity (it is acceptable if it is positive polarity on average, and a case where it temporarily becomes negative polarity is also included). Specifically, a configuration is made such that mist is actively adsorbed to the ink absorber 5b by applying negative voltage to the ink absorber 5b of the platen 5 by the platen applied voltage generation section 58, thereby negatively charging the ink absorber 5b.

FIGS. 7A and 7B are schematic diagrams describing collection of mist, wherein FIG. 7A shows a state where ink is being ejected from the nozzle 30 of the recording head 2 to the recording paper 6 on the platen 5 (a state where the printing process is being carried out) and FIG. 7B shows a state where after the recording paper 6 passes through the platen 5, mist which has floated in the vicinity of the recording head 2 is collected to the platen 5.

In this embodiment, as shown in FIG. 7A, in a state where the recording paper 6 is transported onto the platen 5 and a printing process is then carried out on the recording paper 6, the switch 59 is switched to the ground side, so that voltage is not applied to the ink absorber 5b of the platen 5. Further, as described above, since the nozzle plate 24 is grounded through the cover member 45 and the platen 5 is also in the grounded state, the nozzle plate 24 and the platen 5 have the same potential, so that an electric field is not formed between the two. If ink is ejected from the nozzle 30 of the recording head 2 in this state, when the driving pulse DP of the driving signal COM, that is, positive voltage is input to the individual external electrode 43 of the piezoelectric vibrator 20, since the piezoelectric vibrator 20 and the pressure chamber 28 are insulated from each other by the elastic body film 32 of the vibration plate 25, negative charges are induced in ink in the vicinity of the piezoelectric vibrator 20 in the pressure chamber 28 due to electrostatic induction. Further, in ink in the vicinity of the nozzle 30 which becomes the opposite side to the piezoelectric vibrator 20, positive charges are induced. The positive charges move to the nozzle plate 24 side. However, the positive charges also slightly remain at ink ejected from the nozzle 30. In the ink ejected from the nozzle 30, while it flies toward the recording paper 6, positive charging increases due to the Lenard effect.

An ink droplet ejected from the nozzle 30 is divided into a leading main droplet (a main droplet) Md and a satellite droplet (a sub-droplet) Sd later than the main droplet until the ink droplet lands on the recording paper 6. Some or all of the satellite droplets decrease in speed due to the viscous resistance of air, thereby being turned into mist without reaching the recording paper 6. Here, since there is no electric field between the nozzle plate 24 and the platen 5, occurrence of electrostatic induction in ink is prevented, whereby the satellite droplet Sd or a mist Ms also has a positive charge. The mist Ms which has not landed on the recording paper 6 floats in the vicinity of the nozzle plate 24 of the recording head 2. Then, after the recording paper 6 passes through the platen 5 and before the recording paper 6 that is the next printing target reaches the platen 5, otherwise, after a printing process is finished, the switch 59 is switched to the platen applied voltage generation section 58 side. In this way, as shown in FIG. 7B, a state is created where negative voltage is applied to the ink absorber 5b of the platen 5 by the platen applied voltage generation section 58, so that the ink absorber 5b is negatively charged. In this state, mist having a positive charge, which has floated in the vicinity of the recording head 2, is adsorbed and collected to the ink absorber 5b by an electrostatic force. In addition, timing when the switch 59 is switched to the platen applied voltage generation section 58 side may also be set to be the point of time when the nozzle plate 24 of the recording head 2 has moved to a position where the nozzle plate 24 does not face the platen 5, for example, the home position. Further, when the recording paper 6 that is the next printing target has been sent onto the platen 5, the switch 59 is switched to the ground side, so that a state is created where voltage is not applied to the ink absorber 5b. For this reason, while the recording head 2 ejects ink onto the recording paper 6, electrical charging of the ink absorber 5b does not affect the ejected ink. Further, attachment of mist to the recording paper 6 is prevented.

By adopting the configuration as described above, it becomes possible to collect mist occurring with ejection of ink, so that attachment of mist to a component (for example, an easily charged component such as a driving motor, a driving belt, or a linear scale) in the printer is reduced. As a result, a breakdown due to attachment of mist is suppressed, so that durability and reliability of the printer 1 are improved. Further, since ink is ejected from the nozzle 30 in a state where an electric field is not formed between the nozzle formation face of the recording head 2 and the platen 5, mist is stably positively charged, so that it is possible to more reliably collect mist by applying negative voltage to the ink absorber 5b of the platen 5.

Further, in this embodiment, since voltage is applied to the ink absorber 5b of the platen 5 and on the other hand, voltage is not applied to the main body of the platen 5, in particular, the support projections 5a which come into contact with the recording paper 6, attachment of mist to the support projections 5a is suppressed. In this way, attachment of ink to the recording paper 6 is reduced.

Incidentally, the invention is not limited to the embodiment described above and various modifications can be made on the basis of the statement of the appended claims.

For example, in the first embodiment described above, a configuration in which the nozzle plate 24 is grounded has been illustrated. However, it is not limited thereto. In the case of a configuration in which the nozzle plate 24 has a given potential without being grounded, for example, a configuration can also be adopted in which an electric power supply section (one type of a support section potential setting section) which applies voltage having the same potential as that of the nozzle plate 24 to the platen 5 (the ink absorber 5b) is provided on the ground side of the switch 59 in the first embodiment and in a state where the recording paper 6 has been transported onto the platen 5, the switch 59 is switched to the electric power supply section side. In this way, voltage from the electric power supply section is applied to the platen 5 (the ink absorber 5b), so that the platen 5 (the ink absorber 5b) has the same potential as that of the nozzle plate 24, whereby an electric field is not formed between the nozzle plate 24 and the platen 5 (the ink absorber 5b). Other configurations are the same as those in the first embodiment.

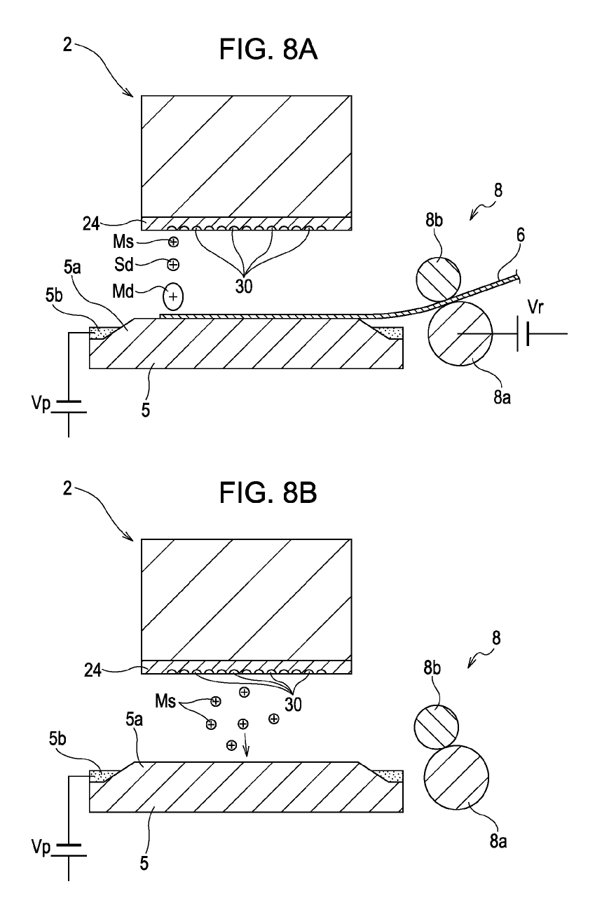

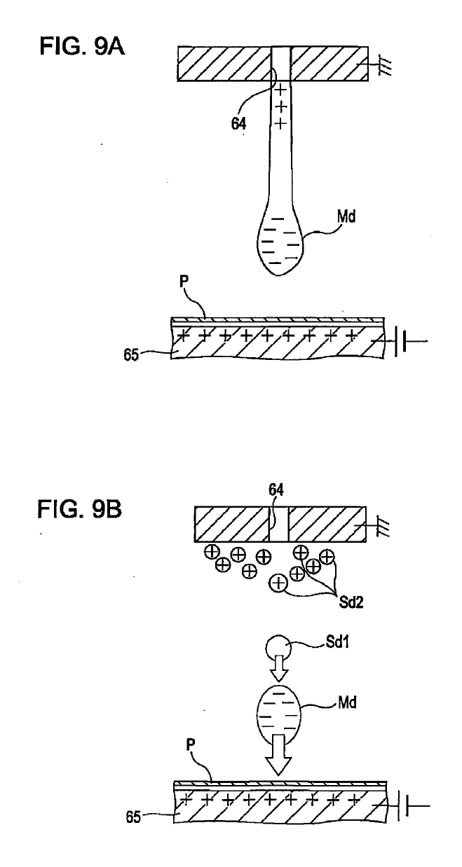

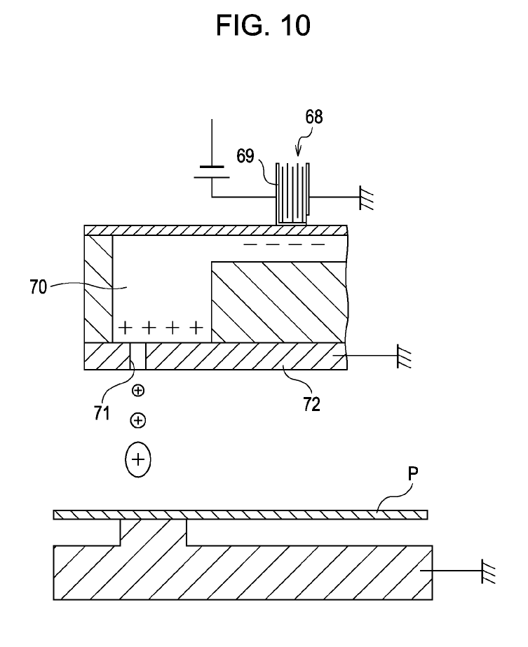

FIGS. 8A and 8B are schematic diagrams describing a second embodiment of the invention.

In the second embodiment shown in FIGS. 8A and 8B, a configuration is provided in which the nozzle plate 24 is not grounded and is positively charged for any reason. Then, voltage Vr is applied to the feed driving roller 8a. The feed driving roller 8a functions as an electrical charging section (one type of a landing target potential setting section in the invention) and electrically charges the recording paper 6 to have the same potential as that of the nozzle plate 24 by taking advantage of the fact that a general recording paper 6 has some conductivity. Further, negative voltage is always applied to the ink absorber 5b of the platen 5. Other configurations are the same as those in the first embodiment.

In this configuration, since before the recording paper 6 is transported to the platen, the recording paper 6 is electrically charged to have the same potential as that of the nozzle plate 24 by the feed driving roller 8a, in a state where the recording paper 6 is transported onto the platen 5 and a printing process is then carried out on the recording paper 6, the nozzle plate 24 and the recording paper 6 have the same potential, so that an electric field is not formed between the two. In this state, if ink is ejected from the nozzle 30 of the recording head 2, the ink ejected from the nozzle 30 is positively charged, similarly to the first embodiment. The mist Ms which has not landed on the recording paper 6 floats in the vicinity of the nozzle plate 24 of the recording head 2. Then, if a state is created where the recording paper 6 passes through the platen 5, so that the recording paper 6 is not present on the platen 5, since the ink absorber 5b is negatively charged by the platen applied voltage generation section 58, as shown in FIG. 8B, mist having a positive charge, which has floated in the vicinity of the recording head 2, is adsorbed and collected to the ink absorber 5b by an electrostatic force. Due to such a configuration, switching control of the switch 59 in the first embodiment is not required, so that the mist suppression effect can be obtained with a simpler configuration.

In addition, in each embodiment described above, as the pressure generation section, the piezoelectric vibrator 20 of a so-called longitudinal vibration type has been illustrated. However, it is not limited thereto and it is also possible to adopt, for example, a piezoelectric vibrator of a so-called flexural vibration type. In this case, regarding the waveform of the driving signal (the ejection driving pulse DP) illustrated in FIG. 6, it becomes a waveform in which the direction of a change in potential, that is, up-and-down is reversed. In addition, it is also possible to apply the invention in the configuration of adopting, as the pressure generation section, a pressure generation section which is driven by application of voltage, such as a heat generation element which causes a fluctuation in pressure by suddenly boiling ink by heat generation or an electrostatic actuator which causes a fluctuation in pressure by displacing a partition wall of a pressure chamber by an electrostatic force.

Further, provided that it is a liquid ejecting apparatus in which liquid election control can be performed with use of a pressure generation section, the invention is not limited to a printer and can also be applied to various ink jet type recording apparatuses such as a plotter, a facsimile machine, and a copying machine, liquid ejecting apparatuses other than a recording apparatus, for example, a display manufacturing apparatus, an electrode manufacturing apparatus, a chip manufacturing apparatus, and the like. Then, in the display manufacturing apparatus, a solution of each color material of R (red), G (green), B (blue) is ejected from a color material ejecting head. Further, in the electrode manufacturing apparatus, a liquid electrode material is ejected from an electrode material ejecting head. In the chip manufacturing apparatus, a solution of biological organic matter is ejected from a biological organic matter ejecting head.

The entire disclosure of Japanese Patent Application No. 2011-083393, filed Apr. 5, 2011 is expressly incorporated by reference herein.

What is claimed is:

1. A liquid ejecting apparatus comprising:
a liquid ejecting head which includes a nozzle formation face, and ejects the liquid from the nozzle toward a landing target;
a support section which is disposed spaced apart from the nozzle formation face of the liquid ejecting head when performing an ejection operation and supports the landing target;
a support section potential setting section which sets the potential of the support section to be the same potential as that of the nozzle formation face; and
a voltage application section which applies voltage having negative polarity to the support section,
wherein in a case where the landing target is present on the support section, the support section is set to have the same potential as that of the nozzle formation face by the support section potential setting section, and on the other hand, in a case where the landing target is not present on the support section, the support section is electrically charged to have negative polarity by the voltage application section.

2. The liquid ejecting apparatus according to claim 1, wherein the voltage application section applies voltage to the support section at the point of time when the liquid ejecting head has moved to a position where the nozzle formation face and the support section do not face each other.

3. A liquid ejecting apparatus comprising:
a liquid ejecting head which includes a nozzle formation face, and ejects the liquid from the nozzle toward a landing target;
a support section which is disposed spaced apart from the nozzle formation face of the liquid ejecting head when performing an ejection operation and supports the landing target;
a landing target potential setting section which sets the potential of the landing target that is transported to the support section to be the same potential as that of the nozzle formation face; and
a voltage application section which applies voltage having negative polarity to the support section.

4. The liquid ejecting apparatus according to claim 1, wherein the support section includes an absorber capable of absorbing a liquid droplet and having conductivity, and
the voltage application section applies voltage having negative polarity to the absorber.

5. A method of controlling a liquid ejecting apparatus which includes a liquid ejecting head which includes a nozzle formation face, and ejects the liquid from the nozzle toward a landing target; a support section which is disposed spaced apart from the nozzle formation face of the liquid ejecting head when performing an ejection operation and supports the landing target; a support section potential setting section which sets the potential of the support section to be the same potential as that of the nozzle formation face; and a voltage application section which applies voltage having negative polarity to the support section, the method comprising:
setting the support section to have the same potential as that of the nozzle formation face by the support section potential setting section in a case where the landing target is present on the support section; and on the other hand,
electrically charging the support section to have negative polarity by the voltage application section in a case where the landing target is not present on the support section.
